(19) United States
(12) Patent Application Publication
(10) Pub. No.: US 2023/0185885 A1
(43) Pub. Date: Jun. 15, 2023

(54) Managing Access To Protected Content Using Device Security Profiles

(71) Applicant: Google LLC, Mountain View, CA (US)

(72) Inventors: Hamid Ali, Edmonds, WA (US); Alex Lee, Belleview, WA (US)

(21) Appl. No.: 17/670,301

(22) Filed: Feb. 11, 2022

Related U.S. Application Data
(60) Provisional application No. 63/289,067, filed on Dec. 13, 2021.

(51) Int. Cl. G06F 21/10

(52) U.S. Cl. CPC G06F 21/10; G06F 2221/0704

(57) ABSTRACT

A digital rights management (DRM) server receives data associated with a device security profile (DSP) from a content owner device. The DSP specifies requirements for client devices to access content items associated with a content owner. The requirements differ based on a resolution level of the accessed content items. The DRM server stores the DSP and an indication of the content owner. The DRM server receives, from a content server storing the content items associated with the content owner, a pull request for DSP updates. The DRM server transmits the DSP to the content server in response to the pull request. The DSP causes the content server to limit client devices that access the content items according to the DSP.

### PRIORITY CLAIM

This application claims priority to U.S. Provisional Patent Application No. 63/289,067, filed on Dec. 13, 2021, the entirety of which is incorporated herein by reference.

### BACKGROUND

Content, such as digital images and videos, may be stored at a server or content storage and distribution system, which is connected to a network such as the Internet. A client device may download the content, allowing a user of the client device to view the content. A content owner may desire to prevent unauthorized distribution of its content or reduce the quality of copies created at client devices without authorization. In some cases, digital rights management (DRM) techniques may be used to prevent copying of the content by the client devices or to reduce the quality of copies of the content made by the client devices.

### SUMMARY

Disclosed herein are aspects of systems, methods, and apparatuses for managing access to protected content using device security profiles.

An aspect of the teachings herein is a method for managing access to protected content using device security profiles. The method can include receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items. The method can include storing, at the DRM server, the DSP and an indication of the content owner. The method can include receiving, from a content server storing the content items associated with the content owner, a pull request for DSP updates. The method can include transmitting the DSP to the content server in response to the pull request, wherein the DSP causes the content server to limit client devices that access the content items according to the DSP (e.g., the DSP is configured to cause the content server to limit access to client devices to the content items according to the DSP).

The resolution level may be based on at least one of a total pixel count, a pixel count per frame, or a pixel dimension measurement. The resolution level may comprise at least one of standard definition (SD), high definition (HD), or 4K. The requirements may differ based on a tag of the accessed content item. The requirements may comprise hardware requirements and/or security requirements of the client devices (e.g., a respective client device) accessing the content items. The DSP may comprise a first data structure representing resolution levels and the requirements for each resolution level, a second data structure representing tags of content items and the requirements for each tag, and a third data structure representing device configurations that have exceptions to the requirements in the first data structure or to the requirements in the second data structure.

The method may further comprise, upon failing to receive, during a predetermined time period, a pull request for the DSP updates from a second content server storing the content items associated with the content owner: pushing the DSP to the second content server. The method may further comprise receiving an update to the DSP from the content owner device; receiving a second pull request from the content server; and transmitting the update to the DSP or an updated version of the DSP to the content server in response to the second pull request.

The method may comprise transmitting, to the content owner device, code for generating a graphical user interface (GUI) to enter the data associated with the DSP; and generating, at the DRM server, the DSP based on the data associated with the DSP obtained at the content owner device via the GUI. The method may comprise receiving, at the content server, the DSP for the content owner; receiving, at the content server, a content request for a content item from a client device, wherein the content item is one of the content items associated with the content owner; determining, based on the content request and the DSP, a resolution level of the content item for provision to the client device; and transmitting the content item at the determined resolution level from the content server to the client device.

Another aspect of the teachings herein is a system for managing access to protected content using device security profiles. The system includes a memory storing instructions. The system includes a processor that can execute the instructions to receive, at a DRM server, data associated with a DSP from a content owner device, wherein the DSP specifies requirements for client devices to access content items associated with a content owner, wherein the requirements differ based on a resolution level of the accessed content items. The processor can execute the instructions to store, at the DRM server, the DSP and an indication of the content owner. The processor can execute the instructions to receive, from a content server storing the content items associated with the content owner, a pull request for DSP updates. The processor can execute the instructions to transmit the DSP to the content server in response to the pull request, wherein the DSP causes the content server to limit client devices that access the content items according to the DSP.

Another aspect is a computer-readable medium for managing access to protected content using device security profiles. The computer-readable medium stores instructions operable to cause a processor to perform operations, such as the operations of the method of the aspect set out above. The instructions may include code for receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items. The instructions may include code for storing, at the DRM server, the DSP and an indication of the content owner. The instructions may include code for receiving, from a content server storing the content items associated with the content owner, a pull request for DSP updates. The instructions may include code for transmitting the DSP to the content server in response to the pull request, wherein the DSP causes the content server to limit client devices that access the content items according to the DSP.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device.

FIG. 2 is a diagram of a computing and communications system.

FIG. 3 is a block diagram of an example of a system in which managing access to protected content using device security profiles may be implemented.

FIG. 4 is a block diagram of an example of a data structure for a device security profile.

FIG. 5 is a flowchart of an example of a method of providing a device security profile to a content server.

FIG. 6 is a flowchart of an example of a method of processing a content request using a device security profile.

FIG. 7 is a diagram of a graphical user interface for entering information associated with a device security profile.

FIG. 8 is a diagram of a graphical user interface for displaying exceptions to a device security profile.

FIG. 9 is a diagram of a graphical user interface for searching device security profiles.

### DETAILED DESCRIPTION

A content owner may develop content (e.g., digital videos, audio files, or images) and provide the content for storage at content servers. The content servers may distribute the content to client devices for viewing or playback thereat. The content owner may desire to prevent unauthorized distribution of its content or reduce the quality of copies created at client devices without authorization. Providing content for playback while limiting further distribution or copying of the provided content may be challenging.

In some cases, digital rights management (DRM) techniques may be used to prevent copying of the content by the client devices or to reduce the quality of copies of the content made by the client devices. A DRM server may provide DRM policy information to the content servers. The DRM server may provide support for encryption schemes and hardware security to restrict client device access to distributed content according to rules defined by content owners.

A content owner may desire to dynamically update rules related to hardware and security policies of devices accessing the content owner's content. This may be desirable, for example, when new hardware appears on the market, when security policies are changed, or when new security vulnerabilities (which can be exploited to make unauthorized copies of content) are discovered.

At least some implementations of the teachings herein relate to the technical problem of how to secure access to content items in a distributed system in response to dynamic changes in the security of devices accessing the content items. The technical solution may include establishing a device security profile (DSP) that can be dynamically updated by a content owner. For example, the content owner may update the DSP in response to changes in security credentials of client devices. The technical solution may include providing a distribution architecture to enable secure and timely availability of the DSP at the content servers.

In some implementations, a DRM server receives data associated with a DSP from a content owner device. The DSP specifies requirements for client devices to access content items associated with a content owner. The requirements differ based on a resolution level of the accessed content items. The resolution level may be based on a total pixel count, a pixel count per frame, a pixel dimension measurement or some combination thereof. For example, the resolution level may be at least one of standard definition (SD) (e.g., 720×480 pixels), high definition (HD) (e.g., 1280×720 pixels or 1920×1080 pixels), or 4K (e.g., 4096×2160 pixels). The DRM server stores the DSP together with an indication of the content owner, for example, within a data structure associated with the content owner. The DRM server receives, from a content server storing the content items associated with the content owner, a pull request for DSP updates. The DRM server transmits the DSP to the content server in response to the pull request. The DSP causes the content server to limit client devices that access the content items according to the DSP.

In some implementations, a content server receives a DSP for a content owner, for example, in response to a pull request for DSP updates from the content server. The DSP specifies requirements for client devices to access content items associated with a content owner. The requirements differ based on a resolution level of the accessed content items. The content server receives a content request for a content item from a client device. The content server determines, based on the content request and the DSP, a resolution level of the content item for provision to the client device. The content server transmits the content item at the determined resolution level to the client device.

Details of these implementations and others are described in additional detail below with initial reference to an environment in which they may be implemented.

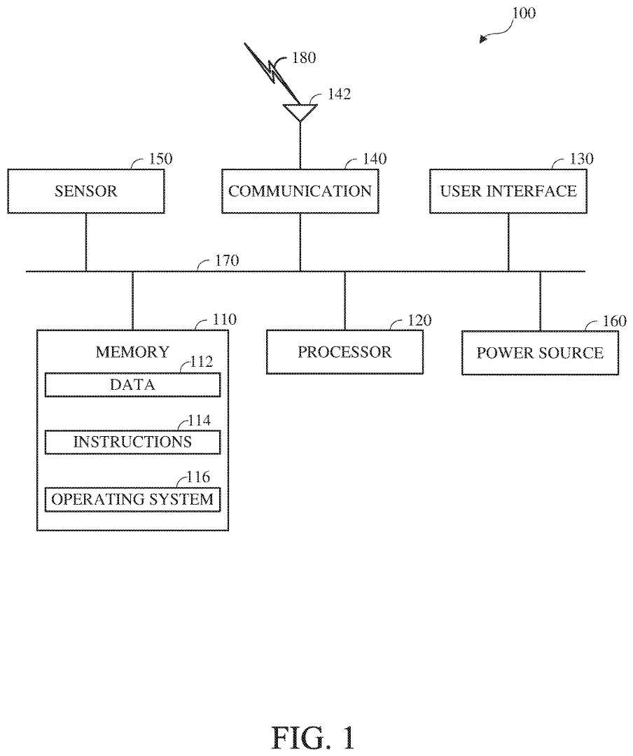

FIG. 1 is a block diagram of an example of a computing device 100. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit. The processor 120 may be a hardware unit and may include processing hardware or processing circuitry. The processor 120 may be or include a single processor or multiple processors.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown as a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 may be, or may include, input data, encoded data, decoded data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program or application, that may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor, a plurality of microprocessors, one or more microprocessor in association with a digital signal processor core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

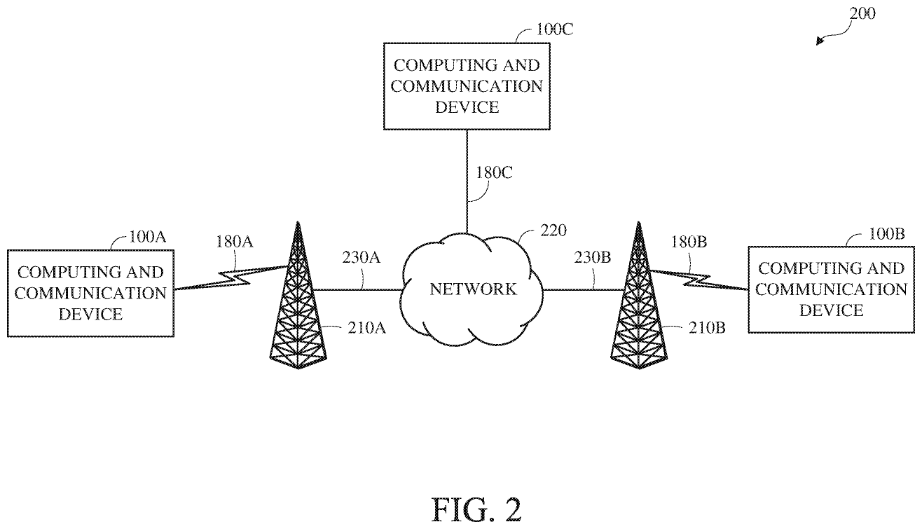

FIG. 2 is a diagram of a computing and communications system 200. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some or all of the functions of a user device, or some or all of the functions of a server and a user device. For example, the server computing and communication device 100C may receive, process, such as encode, process, store, transmit, or a combination thereof data, such as audio data or video data, and one or both of the computing and communication device 100A and the computing and communication device 100B may receive, process, such as decode, process, store, present, or a combination thereof the data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store data, such as encoded data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

As mentioned above, securing access to content items in a distributed system in response to dynamic changes in the security of devices accessing the content items may be achieved by establishing a device security profile (DSP) that can be dynamically updated by a content owner. DSPs may be used to manage access to such protected content.

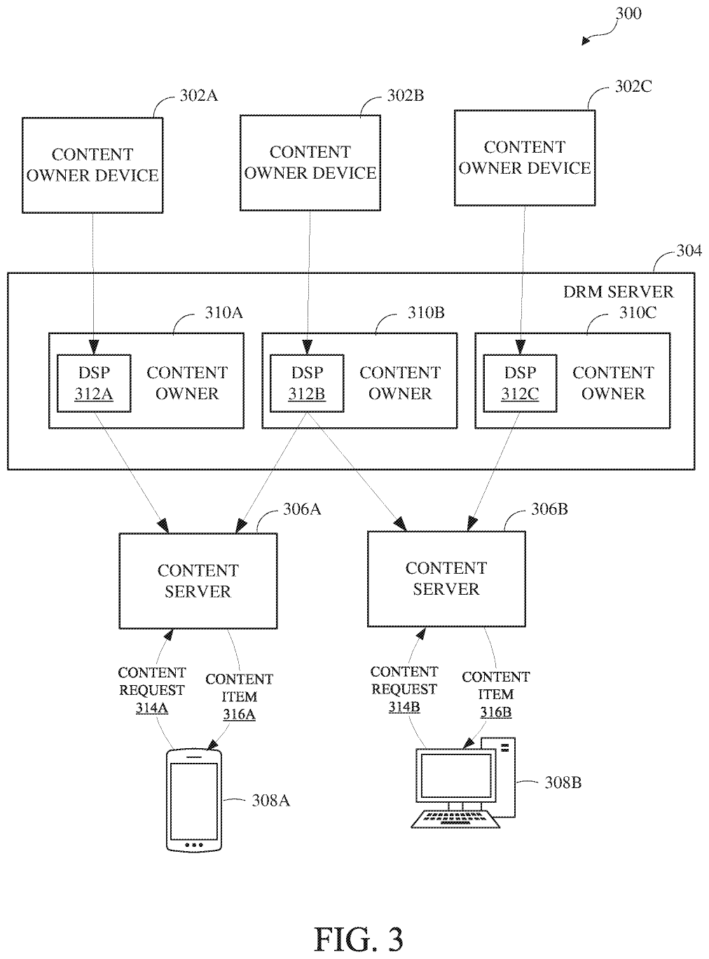

FIG. 3 is a block diagram of an example of a system 300 in which managing access to protected content using DSPs may be implemented. As shown, the system 300 includes content owner devices 302A, 302B, 302C, a DRM server 304, content servers 306A, 306B, and client devices 308A, 308B. Each of the content owner devices 302A, 302B, 302C, the DRM server 304, the content servers 306A, 306B, and the client devices 308A, 308B may correspond to a computing device 100. Also, while three content owner devices 302A, 302B, 302C, a single DRM server 304, two content servers 306A, 306B, and two client devices 308A, 308B are illustrated, some implementations may use other numbers of these devices. The content owner devices 302A, 302B, 302C, the DRM server 304, the content servers 306A, 306B, and the client devices 308A, 308B communicate with one another over a network (e.g., the network 220). Each content server 306A, 306B may be or include a license server.

According to some implementations, the content owner devices 302A, 302B, 302C and the client devices 308A, 308B are user equipment devices, for example, mobile phones, tablet computers, desktop computers, laptop computers, smart watches, personal digital assistants, digital music players, and the like. The DRM server 304 and the content servers 306A, 306B may be server computers.

As shown, the DRM server 304 stores data associated with content owners 310A, 310B, 310C. The content owner 310A is associated with the content owner device 302A. The content owner 310B is associated with the content owner device 302B. The content owner 310C is associated with the content owner device 302C. The data associated with the content owner 310A includes a DSP 312A. The data associated with the content owner 310B includes a DSP 312B. The data associated with the content owner 310C includes a DSP 312C.

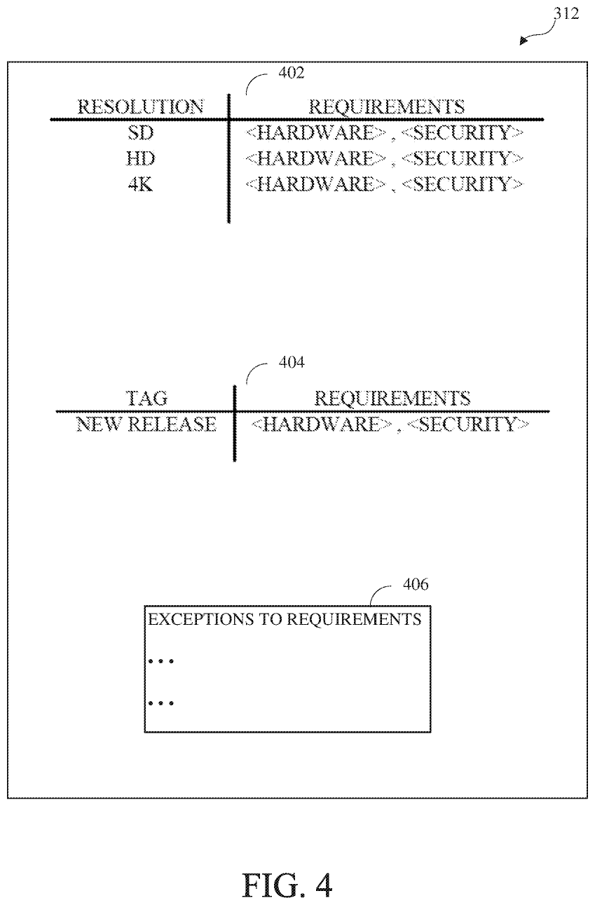

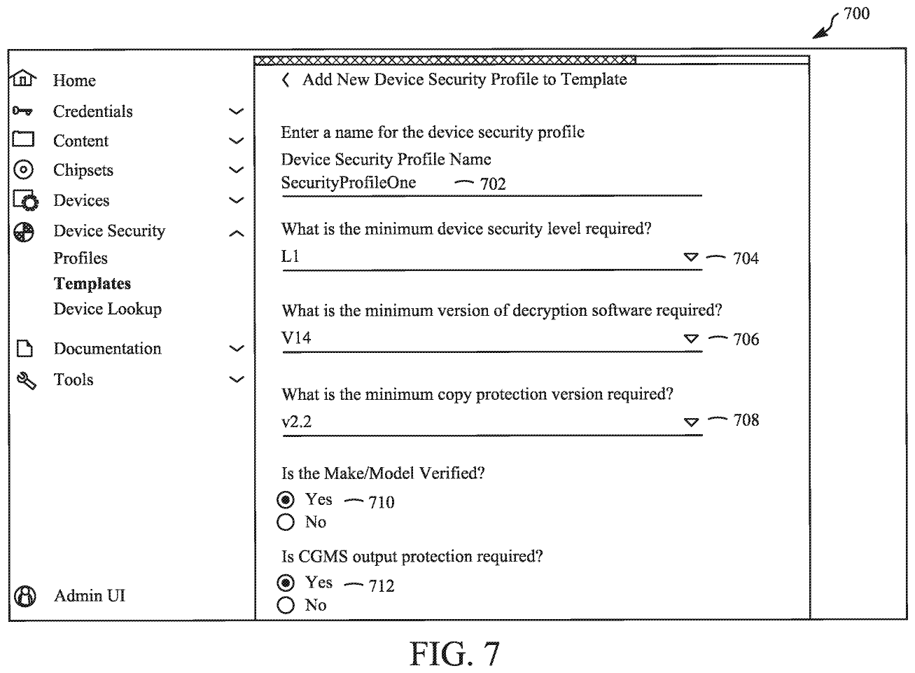

In some implementations, the DRM server 304 transmits, to the content owner device 302A, code for generating a graphical user interface (GUI) to enter data associated with the DSP 312A. An example of a GUI for entering information associated with a device security profile is shown in FIG. 7. The data associated with the DSP 312A may include requirements for displaying content of the content owner associated with the content owner device 302A at one or more resolution levels (e.g., SD, HD, 4K, or the like) or having one or more tags (e.g., providing descriptive data relating to a characteristic of the content item such as new release, drama, comedy, romantic, or the like). For example, the data associated with the DSP 312A may include the data illustrated in FIG. 4 and described below.

A user of the content owner device 302A enters the data associated with the DSP 312A into the GUI. The content owner device 302A transmits the data associated with the DSP 312A that is entered into the GUI to the DRM server 304. The DRM server 304 generates the DSP 312A based on the data and stores the DSP 312A inside the data associated with the content owner 310A. The DSP 312A specifies requirements for client devices, such as the client devices 308A, 308B, to access content items associated with the content owner 310A. The requirements may differ based on a resolution level of the accessed content items. For example, there may be different requirements for accessing SD content and for accessing a HD version of the same content. In an implementation, the requirements for accessing a HD version of ABC-MOVIE are different from the requirements for accessing a 4K version of ABC-MOVIE. The DSPs 312B, 312C are obtained from the content owner devices 302B, 302C and stored in the data associated with the content owners 310B, 310C using a technique like that described herein for the DSP 312A.

The DRM server 304 distributes the DSPs 312A, 312B, 312C to content servers 306A, 306B that store content of the associated content owners 310A, 310B, 310C. As shown, the content server 306A receives the DSPs 312A, 312B but not the DSP 312C because the content server 306A stores content of the content owners 310A, 310B but not content of the content of the content owner 310C. Similarly, the content server 306B receives the DSPs 312B, 312C but not the DSP 312A because the content server 306B stores content of the content owners 310B, 310C but not content of the content of the content owner 310A. Other implementations may store the content in more, fewer, or different content servers.

According to some implementations, the DRM server 304 receives, from the content server 306A storing content items associated with the content owners 310A, 310B, a pull request for DSP updates. The DRM server 304 transmits the DSPs 312A, 312B that have been updated or added since the last pull request to the content server 306A in response to the pull request. The transmitted DSPs 312A, 312B cause the content server to limit or otherwise set terms for the client devices that access the content items of the content owners 310A, 310B according to the DSPs 312A, 312B. The content server 306B similarly transmits a pull request to receive the DSPs 312B, 312C of the content owners 310B, 310C whose content is stored at the content server 306B.

After or concurrently with receiving the DSP 312A of the content owner 310A, the content server 306A receives a content request 314A for a content item 316A of the content owner 310A from the client device 308A. The content request 314A may be or include a license request and may include a hardware status and a security status of the client device 308A. For example, the hardware status may include a make and model of the client device 308A (e.g., Apple iPhone XR®, Google Pixel 4®, or the like) and indicia of any changes to the hardware. The security status may include an operating system version and indicia of any security patches installed at the client device 308A.

The content server 306A determines, based on the content request 314A and the DSP 312A, a resolution level (e.g., SD, HD, 4K, or the like) of the content item 316A for provision to the client device 308A. For example, the resolution level may be determined by comparing the hardware status and the security status in the content request 314A with the requirements for different resolution levels (and for any tags of the content item 316A) specified in the DSP 312A.

In some implementations, the content server 306A may determine, based on the content request 314A and the DSP 312A, that no version of the requested content item may be provided to the client device 308A, and a message informing the client device 308A that the content item 316A is not available may be transmitted to the client device 308A. The content server 306A may determine, based on the DSP 312A, that the client device 308A would be able to access the requested content item 316A following a software update and may transmit a message advising a user of the client device 308A to obtain the software update.

In some implementations, the content server 306A may determine, based on the content request 314A and the DSP 312A, that multiple different resolution levels (e.g., SD or HD, but not 4K) of the requested content item may be provided to the client device 308A. In some cases, the highest resolution level may be transmitted to the client device 308A. In some cases, the resolution level may be selected based on at least one of a network download speed at the client device 308A, display capabilities of the client device 308A, audio playback capabilities of the client device 308A, or user account settings of a user account associated with the client device 308A. The content server 306A may transmit the content item 316A at the determined resolution level to the client device 308A. Similarly, the content server 306B receives, from the client device 308B, the content request 314B (which may be or include a license request) and transmits the content item 316B in response.

FIG. 4 is a block diagram of an example of a data structure for a DSP 312 (e.g., one of the DSPs 312A, 312B, 312C). As shown, the DSP 312 includes a resolution-requirements data structure 402, a tag-requirements data structure 404, and an exceptions data structure 406.

As shown, the resolution-requirements data structure 402 indicates various resolutions (SD, HD, or 4K in this example) and requirements client devices are to meet for provision of content by the content owner at the associated resolution levels. The requirements may include hardware requirements and security requirements. For example, the hardware requirements may include manufacturer, model, and/or other hardware identifiers of a client device. Security requirements may include indicators of at least one of an operating system version, a security policy, a security patch, or software updates installed at the client device.

Similarly, the tag-requirements data structure 404 indicates tags (e.g., “new release”, etc.) requirements client devices are to meet for provision of content by the content owner that includes the indicated tags. The exceptions data structure 406 indicates various devices for which exceptions to the requirements in the data structures 402, 404 may be provided. For example, a company that is both a client device manufacturer and a content owner may desire to provide the highest resolution versions of the company's content to client devices manufactured by the company, even if those devices lack certain hardware or security features that are otherwise required.

FIG. 4 illustrates an example of a data structure for the DSP 312. Other data structures for the DSP 312 may be used in addition to or in place of the data structure illustrated in FIG. 4. The resolution-requirements data structure 402 and the tag-requirements data structure 404 are illustrated as being tables or two-dimensional arrays. However, other types of data structures (e.g., linked lists, stacks, queues, or the like) may be used for the resolution-requirements data structure 402, the tag-requirements data structure 404, or both.

In an example use case, a user of the content owner device 302A creates the DSP 312A via a graphical user interface presented at the content owner device 302A. The DSP 312A specifies that, to access SD content of the content owner 310A, hardware-A and security-policy-A are to exist at the accessing client device. To access HD content of the content owner 310A, hardware-B and security-policy-B are to exist at the accessing client device. To access 4K content of the content owner 310A, hardware-C and security-policy-C are to exist at the accessing client device. To access new release content of the content owner 310A, hardware-D and security-policy-D are to exist at the accessing client device. The DSP 312A can also indicate exceptions for client devices of certain manufacturers. For example, client devices manufactured by manufacturer-ABC are to be able to access all new release or 4K content of the content owner 310A regardless of the hardware or the security policies at those client devices. The DSP 312A is transmitted from the content owner device 302A to the DRM server 304 for storage at the DRM server 304 in a data structure associated with the content owner 310A.

The content server 306A stores content (e.g., video and/or audio files) associated with the content owner 310A. The content server 306A transmits, to the DRM server 304, a pull request for DSP updates. In response to the pull request for DSP updates, the DRM server 304 transmits the DSP 312A to the content server 306A. The content server 306A stores the DSP 312A.

Continuing with the above example, client device 308A transmits, to the content server 306A, a content request 314A to access movie-DEF, which is stored at the content server 306A and associated with the content owner 310A. The content request 314A indicates that the client device 308A includes hardware-A, security-policy-A, security-policy-B, and security-policy-C, and is manufactured by manufacturer-ABC. The content server 306A attempts to determine whether the client device 308A is permitted to receive the SD, HD, or 4K version of movie-DEF. The content server 306A determines, based on the hardware of the client device 308A (has hardware-A, lacks hardware-B, and lacks hardware-C) and the security policies at the client device, (has security-policy-A) that the client device 308A has permission to access an SD version of the movie-DEF, but lacks permission to access HD and 4K versions of the movie-DEF. The content server 306A determines whether the movie-DEF has a new release tag and, upon determining that the movie-DEF lacks the new release tag, determines that the client device 308A is still permitted to access the SD but not the HD and not the 4K versions of the movie-DEF. The content server 306A checks the exceptions in the DSP 312A and determines that, based on the client device 308A being manufactured by manufacturer-ABC, the client device 308A is eligible to obtain the SD, HD, or 4K versions of the movie-DEF.

The content server 306A determines a network speed and display capabilities of the client device 308A to determine whether to transmit the SD, HD, or 4K version of the movie-DEF to the client device. For example, upon determining that the client device 308A has a display unit capable of displaying SD and HD, but not 4K files, and upon determining that the client device 308A is connected to a cellular network with a download speed exceeding a minimum speed for HD transmission (e.g., 5 megabits per second), the content server 306A may provide the HD version of the movie-DEF to the client device 308A. Had the client device 308A been manufactured by a manufacturer other than manufacturer-ABC, the client device 308A would have been ineligible to receive the HD or 4K versions of the movie-DEF under the DSP 312A (due to the lack of hardware-B and hardware-C), and the client device 308A would have received the SD version of the movie-DEF.

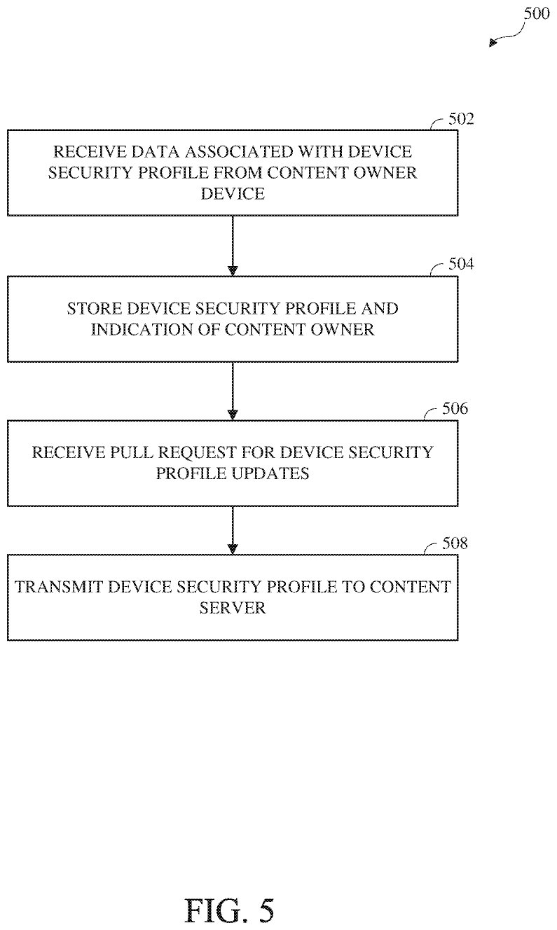

FIG. 5 is a flowchart of an example of a method 500 of providing a device security profile to a content server. The method 500 may be implemented by a DRM server, such as the DRM server 304 shown in FIG. 3, one or more of the computing and communication devices 100A, 100B, 100C shown in FIG. 2, or the computing device 100 shown in FIG. 1.

At block 502, the DRM server receives data associated with a DSP (e.g., the DSP 312, 312A, 312B, 312C) from a content owner device (e.g., the content owner device 302A, 302B, 302C). The DSP specifies requirements for client devices (e.g., the client devices 308A, 308B) to access content items associated with a content owner. The requirements differ based on a resolution level of the accessed content items. The requirements may also differ based on a tag (e.g., “new release”) of the accessed content items. The requirements may include hardware requirements and security requirements.

At block 504, the DRM server stores the DSP and an indication of the content owner (e.g., the content owner 310A, 310B, 310C). The DSP and the indication of the content owner may be stored in a memory (e.g., the memory 110) of the DRM server or in a data repository (e.g., a database) communicating with the DRM server. The DSP may include a first data structure (e.g., the resolution-requirements data structure 402) representing resolution levels and the requirements for each resolution level. The DSP may include a second data structure (e.g., the tag-requirements data structure 404) representing tags of content items and the requirements for each tag. The DSP may include a third data structure (e.g., the exceptions data structure 406) representing device configurations that have exceptions to the requirements in the first data structure or to the requirements in the second data structure.

At block 506, the DRM server receives, from a content server (e.g., the content server 306A) storing the content items associated with the content owner, a pull request for DSP updates. The content server may transmit a pull request for DSP updates when a network speed of the content server exceeds a threshold network speed, when a load on processors of the content server is below a threshold load, or both. The pull request may be transmitted once every threshold time period (e.g., once per day).

At block 508, the DRM server transmits the DSP to the content server in response to the pull request. The DSP causes the content server to limit client devices that access the content items according to the DSP. In some implementations, the DRM server receives an update to the DSP from the content owner device. The DRM server receives a second pull request from the content server. The DRM server transmits the update to the DSP (or an updated version of the DSP) to the content server in response to the second pull request.

In some implementations, the DRM server pushes the DSP to the second content server. The push may occur, for example, upon failing, during a predetermined or defined time period (e.g., one day or seven days), to receive a pull request for the DSP updates from a second content server storing the content items associated with the content owner.

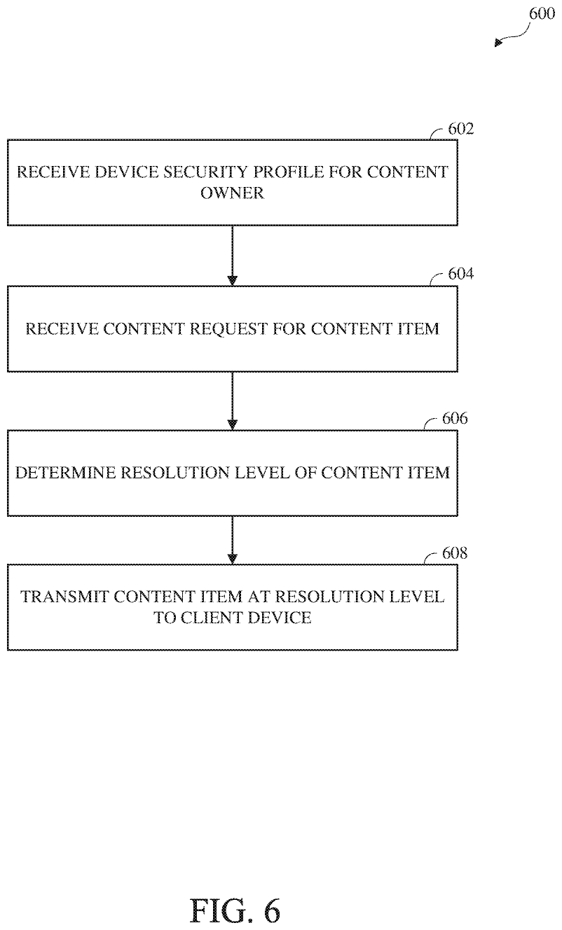

FIG. 6 is a flowchart of an example of a method 600 of processing a content request using a device security profile. The method 600 may be implemented by a content server, such as one or more of the content servers 306A, 306B shown in FIG. 3, one or more of the computing and communication devices 100A, 100B, 100C shown in FIG. 2, or the computing device 100 shown in FIG. 1.

At block 602, the content server receives a DSP (e.g., the DSP 312, 312A, 312B, 312C) for a content owner. The DSP specifies requirements for client devices to access content items associated with a content owner. In some cases, the content server transmits a pull request for DSP updates to a DRM server (e.g., the DRM server 304) and receives the DSP for the content owner in response to the pull request. Alternatively, the DSP may be pushed to the content server from the DRM server.

At block 604, the content server receives a content request (e.g., the content request 314A, 314B) for a content item from a client device (e.g., the client device 308A, 308B). For example, a user of a client device may navigate the client device to an application or a web page associated with the content server, and request content via the application or the webpage.

At block 606, the content server determines, based on the content request and the DSP, a resolution level of the content item (e.g., the content item 316A, 316B) for provision to the client device. For example, the content server may compare the hardware status and the security status of the client device, as indicated in the content request, with hardware requirements and security requirements for provision of content at various resolution levels in the DSP.

At block 608, the content server transmits the content item at the determined resolution level to the client device. The client device may play or display the content item via a user interface (e.g., the user interface 130) of the client device.

In some implementations, the content server transmits, to the DRM server, a second pull request for the DSP updates. The content server receives, in response to the second pull request, an updated DSP to replace the DSP or updates to the previously-stored DSP. The content server replaces, in a memory (e.g., the memory 110) of the content server, the DSP with the updated DSP or the content server incorporates the updates into the DSP.

FIG. 7 is a diagram of a GUI 700 for entering information associated with a DSP. The GUI 700 may be presented at the content owner device 302A, 302B, 302C. As shown, the GUI 700 includes blocks to enter a name for the DSP 702, a minimum device security level 704, a minimum version of decryption software 706, a minimum copy protection version 708, whether the make/model is verified 710, and whether copy generation management system (CGMS) output protection is required 712. The name for the DSP 702 may be any name selected by the user. The minimum device security level 704 may correspond to a minimum-security level, including representations of security software installed at client devices. The minimum version of the decryption software 706 may correspond to the version of the software associated with a media player or other application for viewing content at the client devices. The minimum copy protection version 708 may include a version of copy protection (e.g., high-bandwidth digital content protection (HDCP)) installed at the client devices. The make/model being verified 710 may correspond to whether a content request 314A, 314B from the client devices indicates the make/model of the client devices. Whether the CGMS output protection is required 712 may indicate whether CGMS output protection is required at the client devices.

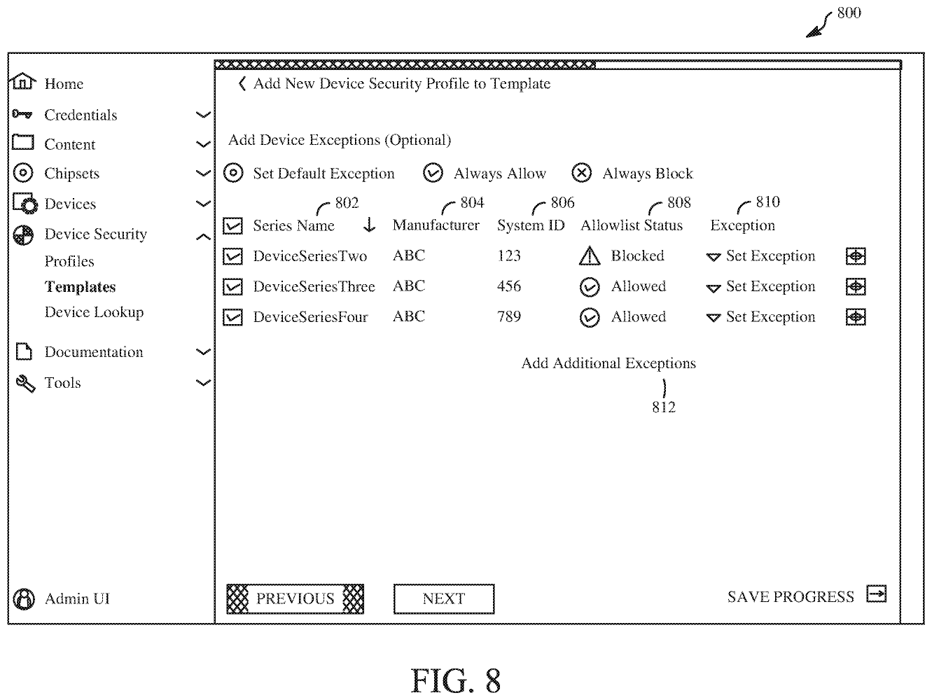

FIG. 8 is a diagram of a GUI 800 for displaying device exceptions to a DSP. The GUI 800 may be presented at the content owner device 302A, 302B, 302C. As shown, the GUI 800 includes a table of exceptions, with columns for a series name 802, a manufacturer 804, a system identifier (ID) 806, an allowlist status 808, and an exception status 810. The GUI 800 also includes an “add additional exceptions” button 812 that, when selected, allows a user to add additional rows to the table of exceptions. The column for the series name 802 indicates series names of devices for which an exception applies. The column for the manufacturer 804 indicates manufacturers of the devices for which the exception applies. The column for the system ID 806 indicates system IDs for the devices for which the exception applies. The column for the allowlist status 808 indicates an allowlist status (e.g., allowed or blocked) for the devices for which the exception applies. The column for the exception status 810 indicates whether the exception is set for the devices for which the exception applies. A user may use a dropdown menu in the column for exception status 810 to select “Yes” or “No” (or “True” or “False” or similar options) to indicate whether the exception listed in any given row should be applied.

The GUIs 700, 800 illustrate some examples of the information included within the hardware and security profiles of a DSP. Not all DSPs require each piece of information indicated therein. Different, more, or fewer pieces of information may be included within a DSP.

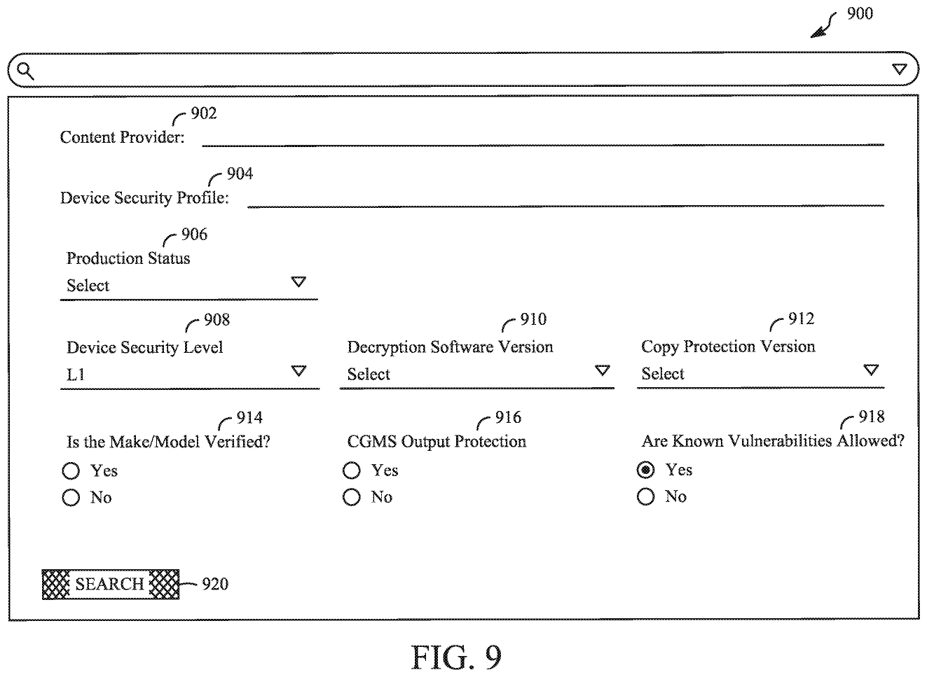

FIG. 9 is a diagram of a GUI 900 for searching DSPs. The GUI 900 may be presented at the content owner device 302A, 302B, 302C. As shown, the GUI 900 includes input boxes for searching DSPs by a content provider name 902 and a DSP name 904. The GUI 900 includes dropdown menus for searching DSPs by a production status 906, a device security level 908, a decryption software version 910, and a copy protection version 912. The GUI 900 includes radio buttons for whether the make/model of the client device is verified 914, whether CGMS output protection is enabled at the client device 916, and whether known security vulnerabilities are allowed 918. The GUI 900 includes a search button 920. When the search button 920 is selected, a device displaying the GUI 900 (e.g., the content owner device 302A, 302B, 302C) searches (e.g., searches in local memory or causes a search to be conducted at the DRM server 304) DSPs associated with the content owner corresponding to the device (or an account logged in at the device) based on whichever ones of the input boxes at 902, 904, the dropdown menus at 906, 908, 910, 912, and the radio buttons at 914, 916, 918 are filled out. The searching causes search results to be generated. All or a portion of the generated search results may be displayed (e.g., in a list) at the device.

Some implementations are described below as numbered examples (Example 1, 2, 3, etc.). These examples are provided as examples only and do not limit the disclosed technology.

Example 1 is a method comprising: receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items; storing, at the DRM server, the DSP and an indication of the content owner; receiving, from a content server storing the content items associated with the content owner, a pull request for DSP updates; and transmitting the DSP to the content server in response to the pull request, wherein the DSP causes the content server to limit client devices that access the content items according to the DSP.

In Example 2, the subject matter of Example 1 includes subject matter wherein the resolution level is based on at least one of a total pixel count, a pixel count per frame, or a pixel dimension measurement.

In Example 3, the subject matter of Example 1, Example 2, or both includes subject matter wherein resolution level comprises at least one of standard definition (SD), high definition (HD), or 4K.

In Example 4, the subject matter of any of Examples 1-3 includes subject matter wherein the requirements differ based on a tag of the accessed content item.

In Example 5, the subject matter of any of Examples 1-4 includes subject matter wherein the requirements comprise hardware requirements and security requirements of the client devices accessing the content items.

In Example 6, the subject matter of any of Examples 1-5 includes subject matter wherein the DSP comprises: a first data structure representing resolution levels and the requirements for each resolution level, a second data structure representing tags of content items and the requirements for each tag, and a third data structure representing device configurations that have exceptions to the requirements in the first data structure or to the requirements in the second data structure.

In Example 7, the subject matter of any of Examples 1-6 includes upon failing, during a defined time period, to receive a pull request for the DSP updates from a second content server storing the content items associated with the content owner, pushing the DSP to the second content server.

In Example 8, the subject matter of any of Examples 1-7 includes receiving an update to the DSP from the content owner device; receiving a second pull request from the content server; and transmitting the update to the DSP or an updated version of the DSP to the content server in response to the second pull request.

In Example 9, the subject matter of any of Examples 1-8 includes, transmitting, to the content owner device, code for generating a graphical user interface (GUI) to enter the data associated with the DSP; and generating, at the DRM server, the DSP based on the data associated with the DSP obtained at the content owner device via the GUI.

In Example 10, the subject matter of any of Examples 1-9 includes receiving, at the content server, the DSP for the content owner; receiving, at the content server, a content request for a content item from a client device, wherein the content item is one of the content items associated with the content owner; determining, based on the content request and the DSP, a resolution level of the content item for provision to the client device; and transmitting the content item at the determined resolution level from the content server to the client device.

Example 11 is a digital rights management (DRM) server, comprising: a memory storing instructions; and a processor that executes the instructions to: receive data associated with a device security profile (DSP) from a content owner device, wherein the DSP specifies requirements for client devices to access content items associated with a content owner, wherein the requirements differ based on a resolution level of the accessed content items, wherein the requirements comprise hardware requirements and security requirements of client devices accessing the content items; store the DSP and an indication of the content owner; receive, from a content server storing the content items associated with the content owner, a pull request for DSP updates; and transmit the DSP to the content server in response to the pull request, wherein the DSP causes the content server to limit the client devices that access the content items according to the DSP.

In Example 12, the subject matter of Example 11 includes subject matter wherein the resolution level is based on at least one of a total pixel count, a pixel count per frame, or a pixel dimension measurement.

In Example 13, the subject matter of Example 11, Example 12, or both includes subject matter wherein the resolution level comprises at least one of standard definition (SD), high definition (HD), or 4K.

In Example 14, the subject matter of any of Examples 11-13 includes subject matter wherein the requirements differ based on a tag of the accessed content item.

In Example 15, the subject matter of any of Examples 11-14 includes subject matter wherein the DSP comprises: a first data structure representing resolution levels and the requirements for each resolution level, a second data structure representing tags of content items and the requirements for each tag, and a third data structure representing device configurations that have exceptions to the requirements in the first data structure or to the requirements in the second data structure.

In Example 16, the subject matter of any of Examples 11-15 includes subject matter wherein the processor executes the instructions to: upon failing, during a predetermined time period, to receive a pull request for the DSP updates from a second content server storing the content items associated with the content owner, push the DSP to the second content server.

In Example 17, the subject matter of any of Examples 11-16 includes subject matter wherein the processor executes the instructions to: receive an update to the DSP from the content owner device; receive a second pull request from the content server; and transmit the update to the DSP or an updated version of the DSP to the content server in response to the second pull request.

In Example 18, the subject matter of any of Examples 11-17 includes subject matter wherein the processor executes the instructions to: transmit, to the content owner device, code for generating a graphical user interface (GUI) to enter the data associated with the DSP; and generate, at the DRM server, the DSP based on the data associated with the DSP obtained at the content owner device via the GUI.

Example 19 is a non-transitory computer-readable medium storing instructions operable to cause a processor to perform operations comprising: receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items, wherein the resolution level is based on at least one of a total pixel count, a pixel count per frame, or a pixel dimension measurement; storing, at the DRM server, the DSP and an indication of the content owner; receiving, from a content server storing the content items associated with the content owner, a pull request for DSP updates; and transmitting the DSP to the content server in response to the pull request, wherein the DSP causes the content server to limit client devices that access the content items according to the DSP.

In Example 20, the subject matter of Example 19 includes subject matter wherein resolution levels comprise at least one of standard definition (SD), high definition (HD), or 4K.

In Example 21, the subject matter of Example 19, Example 20, or both includes subject matter wherein the requirements differ based on a tag of the accessed content item.

In Example 22, the subject matter of any of Examples 19-21 includes subject matter wherein the requirements comprise hardware requirements and security requirements of the client devices accessing the content items.

Example 23 is a method comprising: receiving, at a content server, a device security profile (DSP) for a content owner, wherein the DSP specifies requirements for client devices to access content items associated with a content owner, wherein the requirements differ based on a resolution level of the accessed content items; receiving, at the content server, a content request for a content item from a client device; determining, based on the content request and the DSP, a resolution level of the content item for provision to the client device; and transmitting the content item at the determined resolution level to the client device.

In Example 24, the subject matter of Example 10 or Example 23 includes transmitting a pull request for DSP updates, wherein the DSP for the content owner is received in response to a pull request.

In Example 25, the subject matter of Example 24 includes transmitting a second pull request for the DSP updates; receiving, in response to the second pull request, an updated DSP to replace the DSP or updates to the DSP; and replacing, in a memory of the content server, the DSP with the updated DSP or incorporating the updates into the DSP.

In Example 26, the subject matter of any of Examples 10 or 23-25 includes subject matter wherein resolution levels comprise at least one of standard definition (SD), high definition (HD), and 4K.

In Example 27, the subject matter of any of Examples 10 or 23-26 includes subject matter wherein the requirements differ based on a tag of the accessed content item.

In Example 28, the subject matter of any of Examples 10 or 23-27 includes subject matter wherein the requirements comprise hardware requirements and security requirements.

In Example 29, the subject matter of any of Examples 10 or 23-28 includes subject matter wherein the DSP comprises: a first data structure representing resolution levels and the requirements for each resolution level, a second data structure representing tags of content items and the requirements for each tag, and a third data structure representing device configurations that have exceptions to the requirements in the first data structure or to the requirements in the second data structure.

Example 30 is a content server comprising: a memory storing instructions; and a processor that executes the instructions to: receive a device security profile (DSP) for a content owner, wherein the DSP specifies requirements for client devices to access content items associated with a content owner, wherein the requirements differ based on a resolution level of the accessed content items; receive a content request for a content item from a client device; determine, based on the content request and the DSP, a resolution level of the content item for provision to the client device; and transmit the content item at the determined resolution level to the client device.

In Example 31, the subject matter of Example 30 includes subject matter wherein the processor executes the instructions to: transmit a pull request for DSP updates, wherein the DSP for the content owner is received in response to a pull request.

In Example 32, the subject matter of Example 31 includes subject matter wherein the processor executes the instructions to: transmit a second pull request for the DSP updates; receive, in response to the second pull request, an updated DSP to replace the DSP or updates to the DSP; and replace, in a memory of the content server, the DSP with the updated DSP or incorporating the updates into the DSP.

In Example 33, the subject matter of any of Examples 30-32 includes subject matter wherein resolution levels comprise at least one of standard definition (SD), high definition (HD), or 4K.

In Example 34, the subject matter of any of Examples 30-33 includes subject matter wherein the requirements differ based on a tag of the accessed content item.

In Example 35, the subject matter of any of Examples 30-34 includes subject matter wherein the requirements comprise hardware requirements and security requirements.

In Example 36, the subject matter of any of Examples 30-35 includes subject matter wherein the DSP comprises: a first data structure representing resolution levels and the requirements for each resolution level, a second data structure representing tags of content items and the requirements for each tag, and a third data structure representing device configurations that have exceptions to the requirements in the first data structure or to the requirements in the second data structure.

Example 37 is a non-transitory computer-readable medium storing instructions operable to cause a processor to perform operations comprising: receiving, at a content server, a device security profile (DSP) for a content owner, wherein the DSP specifies requirements for client devices to access content items associated with a content owner, wherein the requirements differ based on a resolution level of the accessed content items; receiving, at the content server, a content request for a content item from a client device; determining, based on the content request and the DSP, a resolution level of the content item for provision to the client device; and transmitting the content item at the determined resolution level to the client device.

In Example 38, the subject matter of Example 37 includes subject matter of the operations comprising: transmitting a pull request for DSP updates, wherein the DSP for the content owner is received in response to a pull request.

In Example 39, the subject matter of Example 38 includes subject matter of the operations comprising: transmitting a second pull request for the DSP updates; receiving, in response to the second pull request, an updated DSP to replace the DSP or updates to the DSP; and replacing, in a memory of the content server, the DSP with the updated DSP or incorporating the updates into the DSP.

In Example 40, the subject matter of any of Examples 37-39 includes subject matter wherein resolution levels comprise at least one of standard definition (SD), high definition (HD), or 4K.

In Example 41, the subject matter of any of Examples 37-40 includes subject matter wherein the requirements differ based on a tag of the accessed content item.

In Example 42, the subject matter of any of Examples 37-41 includes subject matter wherein the requirements comprise hardware requirements and security requirements.

Example 43 is a system comprising processing circuitry configured to perform the method of any of Examples 1-10 or 23-29.

The words “example”, “implementation”, or “aspect” are used herein to mean serving as an example, instance, or illustration. Any aspect or design described herein as “example”, “implementation”, or “aspect” is not necessarily to be construed as preferred or advantageous over other aspects or designs. Rather, use of these words is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “an implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in some implementations, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items;
storing, at the DRM server, the DSP and an indication of the content owner;
receiving, from a content server storing the content items associated with the content owner, a pull request for DSP updates; and
transmitting the DSP to the content server in response to the pull request, wherein the DSP is configured to cause the content server to limit access by client devices to the content items according to the DSP.

2. The method of claim 1, wherein the resolution level is based on at least one of a total pixel count, a pixel count per frame, or a pixel dimension measurement.

3. The method of claim 1, wherein resolution level comprises at least one of standard definition (SD), high definition (HD), or 4K.

4. The method of claim 1, wherein the requirements differ based on a tag of the accessed content item.

5. The method of claim 1, wherein the requirements for the client devices comprise, for a respective client device accessing a content item of the content items, at least one requirement selected from the group consisting of a hardware requirement, a security requirement, or combinations thereof.

6. The method of claim 1, wherein the DSP comprises:
a first data structure representing resolution levels and the requirements for each resolution level,
a second data structure representing tags of content items and the requirements for each tag, and
a third data structure representing device configurations that have exceptions to the requirements in the first data structure or to the requirements in the second data structure.

7. The method of claim 1, comprising:
upon failing, during a predetermined time period, to receive a pull request for the DSP updates from a second content server storing the content items associated with the content owner: pushing the DSP to the second content server.

8. The method of claim 1, comprising:
receiving an update to the DSP from the content owner device;
receiving a second pull request from the content server; and
transmitting the update to the DSP or an updated version of the DSP to the content server in response to the second pull request.

9. The method of claim 1, comprising:
transmitting, to the content owner device, code for generating a graphical user interface (GUI) to enter the data associated with the DSP; and
generating, at the DRM server, the DSP based on the data associated with the DSP obtained at the content owner device via the GUI.

10. The method of claim 1, comprising:
receiving, at the content server, the DSP for the content owner;
receiving, at the content server, a content request for a content item from a client device, wherein the content item is one of the content items associated with the content owner;
determining, based on the content request and the DSP, a resolution level of the content item for provision to the client device; and
transmitting the content item at the determined resolution level from the content server to the client device.

11. A digital rights management (DRM) server, comprising:
a memory storing instructions; and
a processor that executes the instructions to:
receive data associated with a device security profile (DSP) from a content owner device, wherein the DSP specifies requirements for client devices to access content items associated with a content owner, wherein the requirements differ based on a resolution level of the accessed content items, and wherein the requirements comprise, for a respective client device of at least some of the client devices accessing a content item of the content items, at least one requirement selected from the group consisting of a hardware requirement, a security requirement, or combinations thereof;
store the DSP and an indication of the content owner;
receive, from a content server storing the content items associated with the content owner, a pull request for DSP updates; and
transmit the DSP to the content server in response to the pull request, wherein the DSP causes the content server to limit the client devices that access the content items according to the DSP.

12. The DRM server of claim 11, wherein the resolution level is based on at least one of a total pixel count, a pixel count per frame, or a pixel dimension measurement.

13. The DRM server of claim 11, wherein resolution level comprises at least one of standard definition (SD), high definition (HD), or 4K.

14. The DRM server of claim 11, wherein the requirements differ based on a tag of the accessed content item.

15. The DRM server of claim 11, wherein the DSP comprises:
a first data structure representing resolution levels and the requirements for each resolution level,
a second data structure representing tags of content items and the requirements for each tag, and
a third data structure representing device configurations that have exceptions to the requirements in the first data structure or to the requirements in the second data structure.

16. The DRM server of claim 11, wherein the processor executes the instructions to:
upon failing, during a predetermined time period, to receive a pull request for the DSP updates from a second content server storing the content items associated with the content owner: push the DSP to the second content server.

17. The DRM server of claim 11, wherein the processor executes the instructions to:
receive an update to the DSP from the content owner device;
receive a second pull request from the content server; and
transmit the update to the DSP or an updated version of the DSP to the content server in response to the second pull request.

18. The DRM server of claim 11, wherein the processor executes the instructions to:
transmit, to the content owner device, code for generating a graphical user interface (GUI) to enter the data associated with the DSP; and
generate, at the DRM server, the DSP based on the data associated with the DSP obtained at the content owner device via the GUI.

19. A non-transitory computer-readable medium storing instructions operable to cause a processor to perform operations comprising:
receiving, at a digital rights management (DRM) server, data associated with a device security profile (DSP) from a content owner device, wherein the DSP specifies requirements for client devices to access content items associated with a content owner, wherein the requirements differ based on a resolution level of the accessed content items, wherein the resolution level is based on at least one of a total pixel count, a pixel count per frame, or a pixel dimension measurement;
storing, at the DRM server, the DSP and an indication of the content owner;
receiving, from a content server storing the content items associated with the content owner, a pull request for DSP updates; and
transmitting the DSP to the content server in response to the pull request, wherein the DSP causes the content server to limit client devices that access the content items according to the DSP.

20. The non-transitory computer-readable medium of claim 19, wherein the requirements comprise hardware requirements and security requirements of the client devices accessing the content items.
